(19) United States
(12) Patent Application Publication
(10) Pub. No.: US 2005/0011525 A1
(43) Pub. Date: Jan. 20, 2005

(54) Anti-snoring apparatus

(76) Inventor: Stephane Goyette, Boucherville (CA)

Correspondence Address: Stephane GOYETTE;c/o PROTECTIONS EQUINOX INT'L INC., Suite 224, 448 Cote-de-Liesse, Montreal, QC, H4N 2R1, CA

(21) Appl. No.: 10/617,862

(22) Filed: Jul. 14, 2003

(51) Int. Cl. A61C 5/14

(52) U.S. Cl. 128/861

(57) ABSTRACT

An adjuster device for a mouthpiece includes a first stop portion connected to a first bite body and an actuator connected to the first stop portion to move the first bite body along a restricted path of travel relative to a second bite body, which has a second stop portion complementary to the first stop portion. An anti-snoring apparatus and kit including the adjuster device is provided.

### FIELD OF THE INVENTION

The present invention concerns an anti-snoring apparatus, more particularly to an adjustable anti-snoring apparatus.

### BACKGROUND OF THE INVENTION

Anti-snoring devices are well known and widely used. Snoring, while not life-threatening, is a major concern to the sufferer and to their bed partners. Snoring occurs when the tongue is posteriorly displaced and does not contact the posterior pharyngeal wall. The airways are narrowed, which causes air to move rapidly therethrough resulting in vibrations. Currently available anti-snoring devices generally use a mandibular piece that is snuggly fitted to the mandibular teeth and a maxillary piece that snuggly fits onto the maxillary teeth. The devices operate by maintaining the airways free from obstruction by the tongue and the soft tissues of the mouth. Several designs of anti-snoring device exist, some of which are exemplified in the following:
U.S. Pat. No. 6,418,933, issued Jul. 16, 2002, to Strong for “Anti-snoring device and method of making same”;
U.S. Pat. No. 6,305,376, issued Oct. 23, 2001, to Thornton for “Device and method for improving breathing”;
U.S. Pat. No. 6,055,986, issued May 2, 2000, to Meade for “Apparatus and method for the reduction of snoring”;
U.S. Pat. No. 6,041,784, issued Mar. 28, 2000, to Halstrom for “Dental appliance for treatment of snoring and obstructive sleep apnea”;
U.S. Pat. No. 5,829,441, issued Nov. 3, 1998, to Kidd et al. for “Customizable dental device for snoring and sleep apnea treatment”; and
U.S. Pat. No. 5,755,219, issued May 26, 1998, to Thornton for “Device for improved breathing”.

The aforesaid designs, however, suffer from a number of problems. Many of the designs are complex and costly to produce, and may require modification to existing manufacturing machinery. Furthermore, the complexity of some designs may require several visits to the dentist to finely adjust the device to the required comfort and efficiency. Many of the devices include adjustment members that lie directly against the roof of the mouth or against inside of the cheeks and may cause discomfort to the user over prolonged use. Moreover, the adjusters are often cumbersome to operate requiring specialized equipment and use of several adjustment points. In addition, many of the adjusters are located at the front of the device, which reduces the aesthetic appeal of the device and may also cause irritation to the front lip. Furthermore, most of the designs have bite areas, which cover both sets of teeth, which may cause gagging and a long break in time for some patients.

Thus there is a need for an anti-snoring apparatus with an improved adjuster system.

### SUMMARY OF THE INVENTION

The present invention reduces the difficulties and disadvantages of the prior art by providing an anti-snoring apparatus with a novel actuating system, which is easy to operate, inexpensive to manufacture using conventional molding technology using readily available dental grade materials. The previously noted disadvantages of discomfort and complex operation procedures are significantly reduced or essentially eliminated. Advantageously, the actuating system is located towards the rear of the maxillary mouthpiece and mounted discretely as part of the molar complementary part of the mouthpiece. The actuator is operated using a simple key pin, which the patient inserts into the actuator and rotates to adjust the mouthpiece to the desired level of comfort. In addition, patient-only fine-tuning maintains maximum fit, which in turn significantly reduces tongue movement towards away from the posterior pharyngeal wall and maintains unobstructed airways.

Accordingly, in a first embodiment of the present invention, there is provided an adjuster device for a mouthpiece, the device comprising: a first stop portion connected to a first bite body; and an actuator connected to the first stop portion to move the first bite body along a restricted path of travel relative to a second bite body having a second stop portion complementary to the first stop portion.

Typically, the first stop portion includes: a pair of first blocking members, each first blocking member having a first blocking surface disposed towards a plurality of first front teeth.

Typically, a generally planar ledge is connected to each of the first blocking surfaces and extends away therefrom, the ledge having a front ledge portion and rear ledge portion, the ledge being disposed generally orthogonal to the first blocking surface. A first molar engager surface extends from the front ledge portion to a first block rear portion, the first molar engager surface being complementary to a plurality of first rear molars.

Typically, the actuator includes: a pair of blocks, each having a first generally vertical block surface disposed towards each of the first blocking surfaces and spaced apart therefrom to define a first gap therebetween. The blocks further includes: an angled block surface, the angled block surface being angled towards the first front teeth; a second molar engager surface; and a planar surface, the second molar engager surface and the planar surface being parallel to each other, the planar surface being disposed towards the generally planar ledge and spaced apart therefrom to define a second gap therebetween.

Typically, a pair of gap adjusters connects each of the blocks to each of the first blocking members, each of the gaps adjuster being connected to a first frame. Each of the gap adjusters includes: an actuating cylinder rotably mounted on the first frame and having a plurality of pin receiver holes located therein. The gap adjuster further includes: a support shaft, the support shaft and the actuating cylinder being mounted in respective first and second support blocks, the first and second support blocks being embedded in each of the first blocking members, each of the support blocks having a visible direction indicator located thereon.

Typically, a key pin is insertable into one of the pin receiver holes to rotate the actuating cylinder relative to the first frame to move the blocks relative to the first blocking members and in the direction of the visible direction indicators.

Typically, the first frame is substantially embedded in the first bite body and extends between each of the first blocking members to a front portion of the first bite body. A bridge interconnects the first blocking members, the bridge being shaped to lie snuggly against the roof of the mouth. A rearwardly disposed frame portion interconnects the bridge and the first and second support blocks. The first frame includes first and second molar anchors sized and shaped to engage the first bite body with the first rear molars. The first stop portion is located rearwardly of the first bite body.

Typically, the first bite body is a maxillary bite body.

According to second embodiment of the present invention, there is provided an anti-snoring apparatus including a first bite body and a second bite body, the apparatus comprising: a first stop portion connected to the first bite body; a second stop portion connected to the second bite body, the second stop portion being complementary to the first stop portion, the first and second bite bodies when mounted in a mouth define an air passageway therebetween; and an actuator connected to the first stop portion to move the first bite body along a restricted path of travel relative to the second bite body so as to maintain the air passageway substantially free of obstruction.

According to a third aspect of the present invention, there is provided a maxillary mouthpiece comprising: a maxillary bite body having a first stop portion connected thereto; and an actuator connected to the first stop portion to move the maxillary bite body along a restricted path of travel relative to a mandibular bite body having a second stop portion complementary to the first stop portion.

According to a fourth aspect of the present invention, there is provided an anti-snoring kit comprising: a patient-specific maxillary mouthpiece having an adjuster device, as described above; a patient-specific mandibular mouthpiece complementary to the maxillary mouthpiece; and a patient-specific mouth cast, the mouthpieces being mountable on the mouth cast.

### BRIEF DESCRIPTION OF THE DRAWINGS

Further aspects and advantages of the present invention will become better understood with reference to the description in association with the following Figures, wherein:

FIG. 1 is a simplified perspective view of an adjuster device as part of an anti-snoring apparatus located in a patient's mouth;

FIG. 2 is a simplified perspective view showing a maxillary mouthpiece aligned with a mandibular mouthpiece;

FIG. 3 is a simplified perspective view of an actuator located in the maxillary mouthpiece;

FIG. 4 is a simplified perspective rear view of the maxillary mouthpiece engaged with a mouth cast;

FIG. 5 is a simplified perspective view of the mandibular mouthpiece engaged with another mouth cast;

FIG. 6 a simplified side view of the mouthpieces engaged with respective mouth casts; and

FIG. 7 is a simplified side view of the mouthpieces located together.

### DETAILED DESCRIPTION OF THE PREFERRED EMBODIMENTS

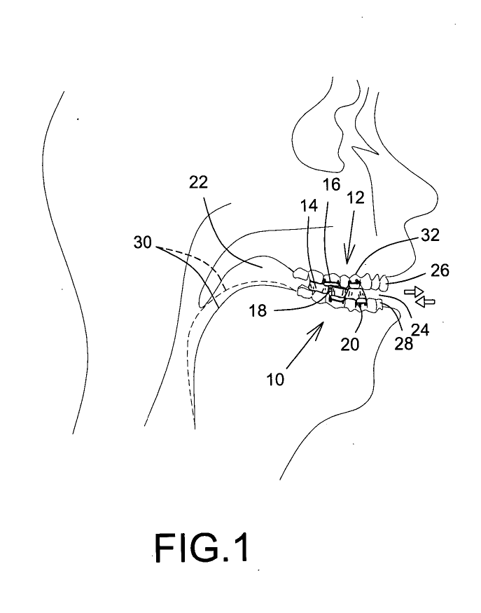

Referring now to FIG. 1, an embodiment of an adjuster device is shown generally at 10 as part of an anti-snoring apparatus 12. Broadly speaking, the adjuster device 10 includes a first stop portion 14, a first, maxillary bite body 16, and an actuator 18. In this embodiment, a second mandibular bite body 20 is included and is complementary to the first maxillary bite body 16, and when fitted in the mouth of a patient define an air passageway 22 that extends from a gap 24 from between the front upper and lower incisors 26, 28 to the posterior of the tongue 30.

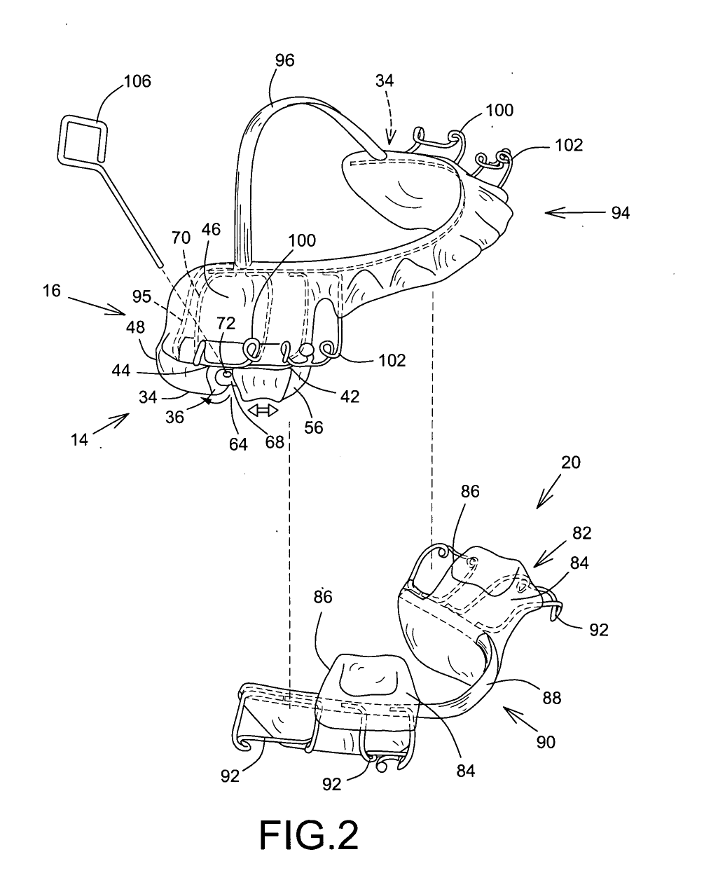

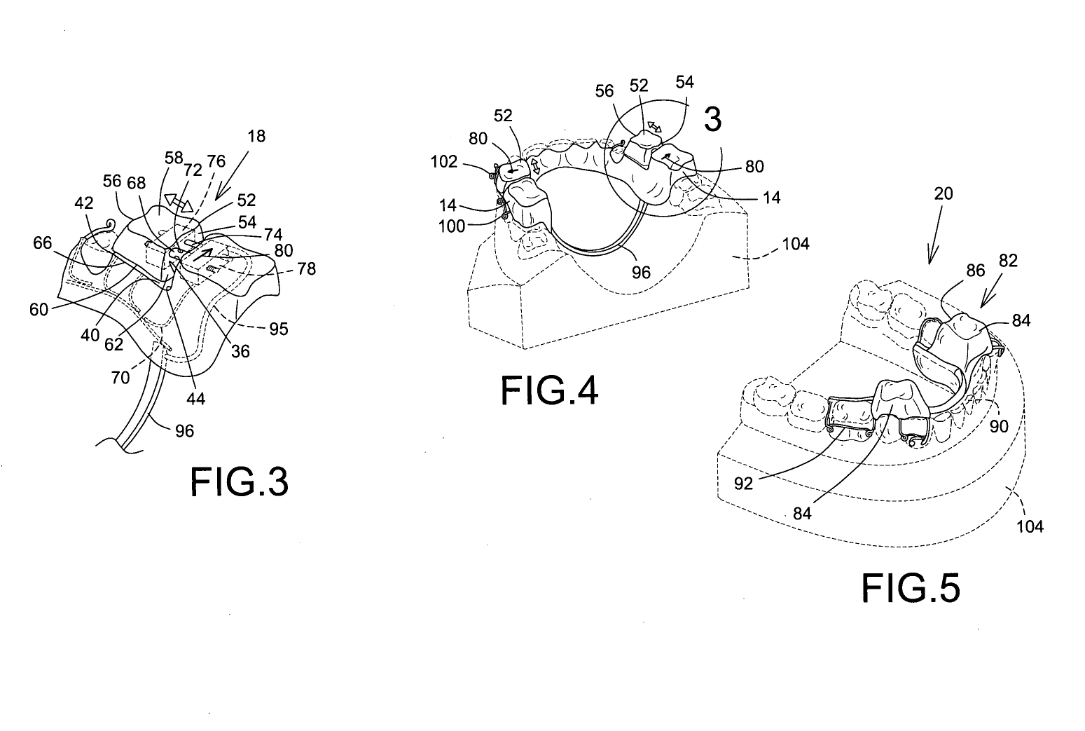

Referring now to FIGS. 2 and 3, the first stop portion 14 is connected to the rear of the first bite body 16 and is located to engage two or four upper rear molars 32. The first stop portion 14 includes a pair of first blocking members 34. Since both blocking members 34 are essentially identical, only one will now be described in detail. The blocking member 34 includes a first blocking surface 36, which is disposed towards the front incisor teeth 26. A generally planar ledge 40 is connected to each of the blocking surface 36 and has a front ledge portion 42 and rear ledge portion 44. The ledge 40 extends away the blocking surface 36 and is disposed generally orthogonal thereto. A first molar engager surface 46 extends from the front ledge portion 42 to a first blocking member rear portion 48. The first molar engager surface 46 is complementary to the rear molars 32, the complementarities being introduced during the manufacture of the mouthpiece, as described below.

As best illustrated in FIG. 1, the tongue's location is of concern to the patient during the fitting of the apparatus 12 into the mouth. For reduction in snoring, the tongue should be located away from the posterior of the mouth and down towards the posterior pharyngeal wall (as illustrated by the outline). The patient can maximize the efficiency of the apparatus by fine-tuning the location of the apparatus 12 in the mouth by using the actuator 18 of the present invention. The actuator 18 is connected to the first stop portion 14 and, when activated, moves the first bite body 16 along a restricted path of travel relative to the second bite body 20 to maintain the air passageway 22 substantially free of obstruction by the tongue.

Referring now to FIGS. 2, 3 and 4, the actuator 18 includes a pair of blocks 52. The blocks 52 are essentially identical and as such, only one will be described in detail. The block 52 includes a first generally vertical block surface 54, an angled block surface 56, a second molar engager surface 58 and a planar surface 60. The vertical block surface 54 is disposed towards the first blocking surfaces 36, whereas the angled block surface 56 is angled towards the first front teeth 38. A gap adjuster 62 spaces the block 52 and the blocking surface 36 apart to define a first gap 64 therebetween. The second molar engager surface 58 and the planar surface 60 are parallel to each other. The planar surface 60 is disposed towards the ledge 40 and spaced apart therefrom to define a second gap therebetween 66.

As best illustrated in FIG. 3, the gap adjuster 62 includes an actuating cylinder 68 rotably mounted on a first frame 70 and includes a plurality of pin receiver holes 72 located therein. A support shaft 74 connects the block 52 and the blocking member 34 together and extends between two support blocks 76, 78, which are embedded in the blocking members 34 and the blocks 52. The actuating cylinder 68 is also connected between the support blocks 76, 78. The support blocks 76, 78 include a visible direction indicator 80, typically an arrow, embedded on the surface of the support blocks 76, 78.

Referring now to FIGS. 2 and 5, a second stop portion 82 is connected to the second mandibular bite body 20 and is complementary to the first stop portion 14. The second stop portion 82 includes a pair of second blocking members 84, which are interlockable with each of the blocks 52 of the actuator 18.

Each of the second blocking members 84 includes an angled blocking surface 86, which is complementary to the angled block surface 56 and is disposed towards the front of the second bite body 20. The second bite body 20 includes a second frame 88 substantially embedded therein and extends between each of the second blocking members 84 and a front portion 90 of the second bite body 20. The second frame 88 has a plurality of molar anchors 92.

Referring now to FIGS. 2, 4, and 5, the first frame 70 is substantially embedded in the first bite body 16 and extends between each of the first blocking members 34 to a front portion 94 of the first bite body 16. A bridge 96 interconnects the first blocking members 34 and shaped to lay snuggly against the roof of the mouth. A rearwardly disposed frame portion 95 interconnects the bridge 96 and the first and second support blocks 76, 78. The first frame 70 includes first and second molar anchors 100, 102, which are sized and shaped to engage the first bite body 16 with the first rear molars. The first and second frames 70, 88 are typically made from dental grade stainless steel.

Both the mandibular and maxillary bite bodies 16, 20 are made from translucent dental grade acrylic material and are typically designed to maintain a sufficient separation of the two bodies, without covering the front incisor teeth. The materials used are easily cleaned, hard wearing and can be formed to precisely fit into the patient's mouth without sharp edges, which may cause discomfort.

Operation

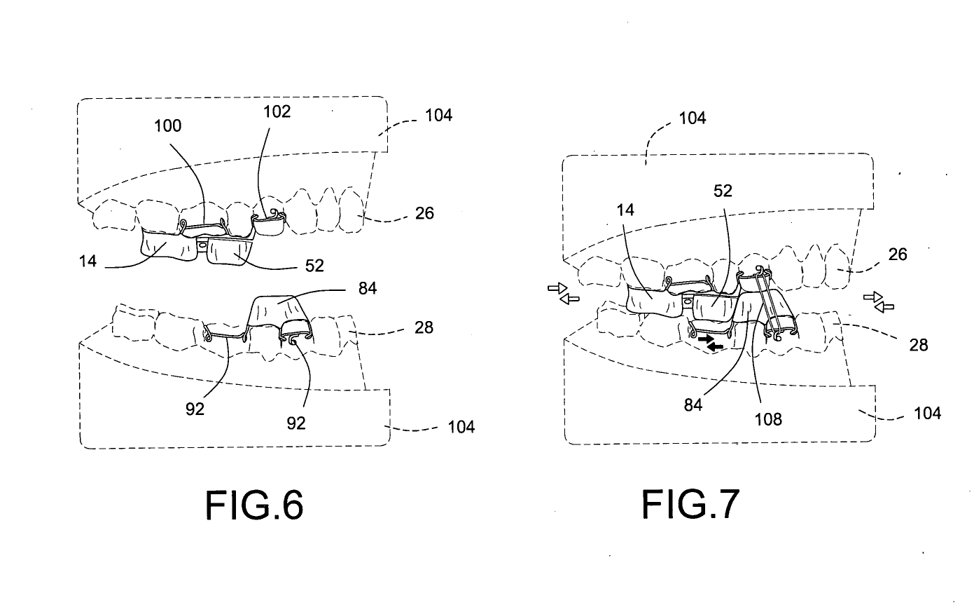

Referring now to FIGS. 2, 6, and 7, the apparatus 10 is typically supplied in kit form including the maxillary mouthpiece 16 that includes an adjuster device 10 of the present invention, the mandibular mouthpiece 20 complementary to the maxillary mouthpiece, and a patient-specific mouth cast 104. Both the mouthpieces are patient-specific. As best illustrated in FIGS. 2 and 7, a key pin 106 to actuate the adjuster device 10 and a pair of resilient connector bands 108 to releasably connect the mouthpieces together if desired are also supplied. The patient, if desired, can store and maintain the shape of the apparatus, when not in use, using the mouth cast 104.

The mouthpieces 16, 20 are typically manufactured from a mold taken from the patient's mouth at the dentist's office and sent to a dental laboratory where they are manufactured from a cast taken from the mold. The dentist, once in receipt of the patient specific mouthpieces fits them into the patient's mouth. To achieve the desired level of comfort and to maximize the tongue depression effect of the apparatus, the dentist fine tunes the fit by inserting the key pin 106 into one of the pin receiver holes 72 located in the actuator cylinder and rotates the cylinder in the direction of the visible direction indicators 80, as best illustrated in FIG. 3. The actuator 18 moves the blocks 52 towards or away from the blocking members, as best illustrated by the solid arrows in FIG. 7, to achieve so that the blocking members and the blocks interlock in an abutting arrangement to secure the mouthpieces in place. Once the desired fit and comfort level are achieved, the patient can then perform maintenance tightening himself should the fit become loose.

1. An adjuster device for a mouthpiece, the device comprising:
a first stop portion connected to a first bite body; and
an actuator connected to the first stop portion to move the first bite body along a restricted path of travel relative to a second bite body having a second stop portion complementary to the first stop portion.

2. The device, according to claim 1, in which the first stop portion includes:
a pair of first blocking members, each first blocking member having a first blocking surface disposed towards a plurality of first front teeth.

3. The device, according to claim 2, in which:
a generally planar ledge is connected to each of the first blocking surfaces and extends away therefrom, the ledge having a front ledge portion and rear ledge portion, the ledge being disposed generally orthogonal to the first blocking surface.

4. The device, according to claim 3, in which:
a first molar engager surface extends from the front ledge portion to a first block rear portion, the first molar engager surface being complementary to a plurality of first rear molars.

5. The device, according to claim 3, in which the actuator includes:
a pair of blocks, each having a first generally vertical block surface disposed towards each of the first blocking surfaces and spaced apart therefrom to define a first gap therebetween.

6. The device, according to claim 5, in which each of the blocks further includes:
an angled block surface, the angled block surface being angled towards the first front teeth;
a second molar engager surface; and
a planar surface, the second molar engager surface and the planar surface being parallel to each other, the planar surface being disposed towards the generally planar ledge and spaced apart therefrom to define a second gap therebetween.

7. The device, according to claim 6, in which:
a pair of gap adjusters connects each of the blocks to each of the first blocking members, each of the gaps adjuster being connected to a first frame.

8. The device, according to claim 7, in which each of the gap adjusters includes:
an actuating cylinder rotably mounted on the first frame and having a plurality of pin receiver holes located therein.

9. The device, according to claim 8, in which the gap adjuster further includes:
a support shaft, the support shaft and the actuating cylinder being mounted in respective first and second support blocks, the first and second support blocks being embedded in each of the first blocking members, each of the support blocks having a visible direction indicator located thereon.

10. The device, according to claim 9, in which:
a key pin is insertable into one of the pin receiver holes to rotate the actuating cylinder relative to the first frame to move the blocks relative to the first blocking members and in the direction of the visible direction indicators.

11. The device, according to claim 10, in which:
the first frame is substantially embedded in the first bite body and extends between each of the first blocking members to a front portion of the first bite body.

12. The device, according to claim 11, in which:
a bridge interconnects the first blocking members, the bridge being shaped to lie snuggly against the roof of the mouth.

13. The device, according to claim 12, in which:
a rearwardly disposed frame portion interconnects the bridge and the first and second support blocks.

14. The device, according to claim 13, in which:
the first frame includes first and second molar anchors sized and shaped to engage the first bite body with the first rear molars.

15. The device, according to claim 14, in which:
the first stop portion is located rearwardly of the first bite body.

16. The device, according to claim 15, in which:
the first bite body is a maxillary bite body.

17. Anti-snoring apparatus including a first bite body and a second bite body, the apparatus comprising:
a first stop portion connected to the first bite body;
a second stop portion connected to the second bite body, the second stop portion being complementary to the first stop portion, the first and second bite bodies when mounted in a mouth define an air passageway therebetween; and
an actuator connected to the first stop portion to move the first bite body along a restricted path of travel relative to the second bite body so as to maintain the air passageway substantially free of obstruction.

18. The apparatus, according to claim 17, in which the first stop portion includes:
a pair of first blocking members, each first blocking member having a first blocking surface disposed towards a plurality of first front teeth.

19. The apparatus, according to claim 18, in which:
a generally planar ledge is connected to each of the first blocking surfaces and extends away therefrom, the ledge having a front ledge portion and rear ledge portion, the ledge being disposed generally orthogonal to the first blocking surface.

20. The apparatus, according to claim 19, in which:
a first molar engager surface extends from the front ledge portion to a first block rear portion, the first molar engager surface being complementary to a plurality of first rear molars.

21. The apparatus, according to claim 20, in which the actuator includes:
a pair of blocks, each having a first generally vertical block surface disposed towards each of the first blocking surfaces and spaced apart therefrom to define a first gap therebetween.

22. The apparatus, according to claim 21, in which each of the blocks further includes:
an angled block surface, the angled block surface being angled towards the first front teeth;
a second molar engager surface; and
a planar surface, the second molar engager surface and the planar surface being parallel to each other, the planar surface being disposed towards the generally planar ledge and spaced apart therefrom to define a second gap therebetween.

23. The apparatus, according to claim 22, in which:
a pair of gap adjusters connects each of the blocks to each of the first blocking members, each of the gaps adjuster being connected to a first frame.

24. The apparatus, according to claim 23, in which each of the gap adjusters includes:
an actuating cylinder rotably mounted on the first frame and having a plurality of pin receiver holes located therein.

25. The apparatus, according to claim 24, in which the gap adjuster further includes:
a support shaft, the support shaft and the actuating cylinder being mounted in respective first and second support blocks, the first and second support blocks being embedded in each of the first blocking members, each of the support blocks having a visible direction indicator located thereon.

26. The apparatus, according to claim 25, in which:
a key pin is insertable into one of the pin receiver holes to rotate the actuating cylinder relative to the first frame to move the blocks relative to the first blocking members and in the direction of the visible direction indicators.

27. The apparatus, according to claim 26, in which:
the first frame is substantially embedded in the first bite body and extends between each of the first blocking members to a front portion of the first bite body.

28. The apparatus, according to claim 27, in which:
a bridge interconnects the first blocking members, the bridge being shaped to lie snuggly against the roof of the mouth.

29. The apparatus, according to claim 28, in which:
a rearwardly disposed frame portion interconnects the bridge and the first and second support blocks.

30. The apparatus, according to claim 29, in which:
the first frame includes first and second molar anchors sized and shaped to engage the first bite body with the first rear molars.

31. The apparatus, according to claim 30, in which:
the first stop portion is located rearwardly of the first bite body.

32. The apparatus, according to claim 31, in which:
the first bite body is a maxillary bite body.

33. The apparatus, according to claim 17, in which the second stop portion includes:
a pair of second blocking members, each second blocking member being interlockable with each of the blocks of the actuator.

34. The apparatus, according to claim 33, in which each of the second blocking members includes an angled blocking surface complementary to the angled block surface.

35. The apparatus, according to claim 34, in which:
the second bite body includes a second frame substantially embedded therein and extending between each of the second blocking members and a front portion of the second bite body, the second frame having a plurality of molar anchors.

36. The apparatus, according to claim 35, in which:
the second blocking members are frontwardly disposed of the second bite body.

37. The apparatus, according to claim 36, in which:
the second bite body is a mandibular bite body.

38. The apparatus, according to claim 17, in which:
a pair of resilient connector bands releasably connect the first and second bite bodies together.

39. A maxillary mouthpiece comprising:
a maxillary bite body having a first stop portion connected thereto; and
an actuator connected to the first stop portion to move the maxillary bite body along a restricted path of travel relative to a mandibular bite body having a second stop portion complementary to the first stop portion.

40. The mouthpiece, according to claim 39, in which the first stop portion includes:
a pair of blocking members, each blocking member having a blocking surface disposed towards a plurality of maxillary front teeth.

41. The mouthpiece, according to claim 40, in which:
a generally planar ledge is connected to each of the blocking surfaces and extends away therefrom, the ledge having a front ledge portion and rear ledge portion, the ledge being disposed generally orthogonal to the blocking surface.

42. The mouthpiece, according to claim 41, in which:
a first maxillary molar engager surface extends from the front ledge portion to a first block rear portion, the maxillary molar engager surface being complementary to a plurality of maxillary rear molars.

43. The mouthpiece, according to claim 39, in which the actuator includes:
a pair of blocks, each having a generally vertical block surface disposed towards each of the blocking surfaces and spaced apart therefrom to define a gap therebetween.

44. The mouthpiece, according to claim 43, in which each of the blocks further includes:
an angled block surface, the angled block surface being angled towards the maxillary front teeth;
a second maxillary molar engager surface; and
a planar surface, the second maxillary molar engager surface and the planar surface being parallel to each other, the planar surface being disposed towards the generally planar ledge and spaced apart therefrom to define a second gap therebetween.

45. The mouthpiece, according to claim 41, in which:
a pair of gap adjusters connects each of the blocks to each of the blocking members, each of the gaps adjuster being connected to a frame.

46. The mouthpiece, according to claim 42, in which each of the gap adjusters includes:
an actuating cylinder rotably mounted on the frame and having a plurality of pin receiver holes located therein.

47. The mouthpiece, according to claim 43, in which the gap adjuster further includes:
a support shaft, the support shaft and the actuating cylinder being mounted in respective first and second support blocks, the first and second support blocks being embedded in each of the blocking members, each of the support blocks having a visible direction indicator located thereon.

48. The mouthpiece, according to claim 44, in which:
a key pin is insertable into one of the pin receiver holes to rotate the actuating cylinder relative to the frame to move the blocks relative to the blocking members and in the direction of the visible direction indicators.

49. An anti-snoring kit comprising:
a patient-specific maxillary mouthpiece having an adjuster device, according to claim 1;
a patient-specific mandibular mouthpiece complementary to the maxillary mouthpiece; and
a patient-specific mouth cast, the mouthpieces being mountable on the mouth cast.

50. The kit, according to claim 47, further including a key pin to actuate the adjuster device.

51. The kit, according to claim 50, further including a pair of resilient connector bands to releasably connect the mouthpieces together.
